(19) United States
(12) Patent Application Publication
(10) Pub. No.: US 2025/0262118 A1
(43) Pub. Date: Aug. 21, 2025

(54) CANE THAT SERVES AS MASSAGER

(71) Applicant: Ming-Hsien Lee, Taichung City (TW)

(72) Inventor: Ming-Hsien Lee, Taichung City (TW)

(21) Appl. No.: 18/581,400

(22) Filed: Feb. 20, 2024

(51) Int. Cl. A61H 15/00; A45B 5/00; A45B 9/02; A45B 9/04; A61H 23/00; A61H 39/04; A63B 29/08

(52) U.S. Cl. CPC A61H 15/0092; A45B 5/00; A45B 9/02; A45B 9/04; A61H 23/006; A61H 39/04; A63B 29/08; A61H 2015/0042; A61H 2201/0107; A61H 2201/0157; A61H 2201/0161; A61H 2201/0165; A61H 2201/1633; A61H 2201/1676

(57) ABSTRACT

A cane also serves as a massager, including: a cane head, which includes a grip portion and an inserting and joining portion, the grip portion being gripped and held by a hand of a user, the inserting and joining portion having one end connected to one side of the grip portion, a free end of the inserting and joining portion including a massage sphere; a cane body, the inserting and joining portion of the cane head being mounted, in a detachable manner, in an interior of a top end of the cane body; and a support base, which is mounted, in a detachable manner, to a bottom end of the cane body for supporting on ground. When the cane head and the cane body are detached, the massage sphere can be used by the user to serve as a tool for massaging the body to thereby enhance convenience of use.

### BACKGROUND OF THE INVENTION

### (a) Technical Field of the Invention

The present invention relates to a walking cane, and more particularly to a walking cane that can also serve as a massager.

### (b) Description of the Prior Art

A cane is generally made up of a cane body that is in the form of an elongate slender bar, a cane head that is connected transversely to a top end of the cane body and a base that is connected to a bottom end of the cane body. The cane head functions as a handle or grip to be held by a user's hand, and the base has an effect of supporting on the ground. The cane body provide a desired height to allow the cane head to be located at such a height as to be easily gripped by the user.

However, a walking cane provides only a function of supporting when the user is walking. In case that massaging the muscles or acupuncture points of the user's body is desired either at home or moving outdoors, the user has to pick up a massager. This may not be inconvenient when the user is staying at home, but is apparently inconvenient when the user is going outdoors.

### SUMMARY OF THE INVENTION

Thus, in order to overcome the above problem that the conventional walking cane has only monotonous functionality and does not serve as an easy massager when a user is staying outdoors so as to make it inconvenient in use, the present invention provides a cane that also serves as a massager, comprising: a cane head, which comprises a grip portion and an inserting and joining portion, the grip portion being gripped and held by a hand of a user, the inserting and joining portion having one end connected to one side of the grip portion, a free end of the inserting and joining portion comprising a massage sphere; a cane body, the inserting and joining portion of the cane head being mounted, in a detachable manner, in an interior of a top end of the cane body; and a support base, which is mounted, in a detachable manner, to a bottom end of the cane body for supporting on ground; and when the cane head and the cane body are detached from each other, the massage sphere can be used by the user to serve as a tool for massaging the body to thereby enhance convenience of use.

### BRIEF DESCRIPTION OF THE DRAWINGS

FIG. 1 is an exploded view showing a first preferred embodiment of the present invention.

FIG. 2 is a perspective view showing the embodiment of FIG. 1 in an assembled form.

FIG. 3 is a cross-sectional view showing the embodiment of FIG. 1 in an assembled form.

FIG. 4 is a perspective view showing components of the embodiment of FIG. 1.

FIG. 5 is a perspective view showing components of the embodiment of FIG. 1.

FIG. 6 is a perspective view showing a second preferred embodiment of the present invention.

### DETAILED DESCRIPTION OF THE PREFERRED EMBODIMENTS

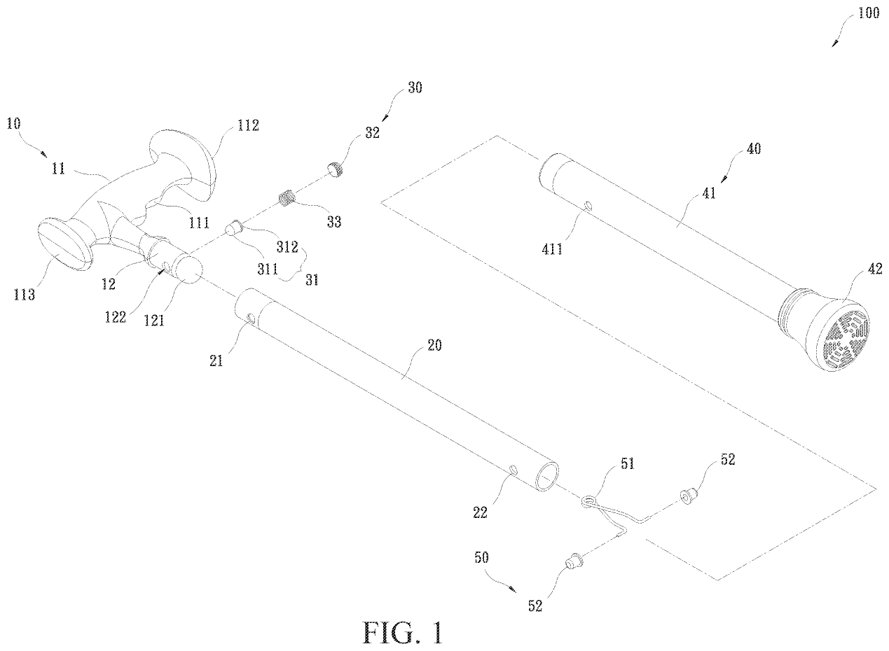

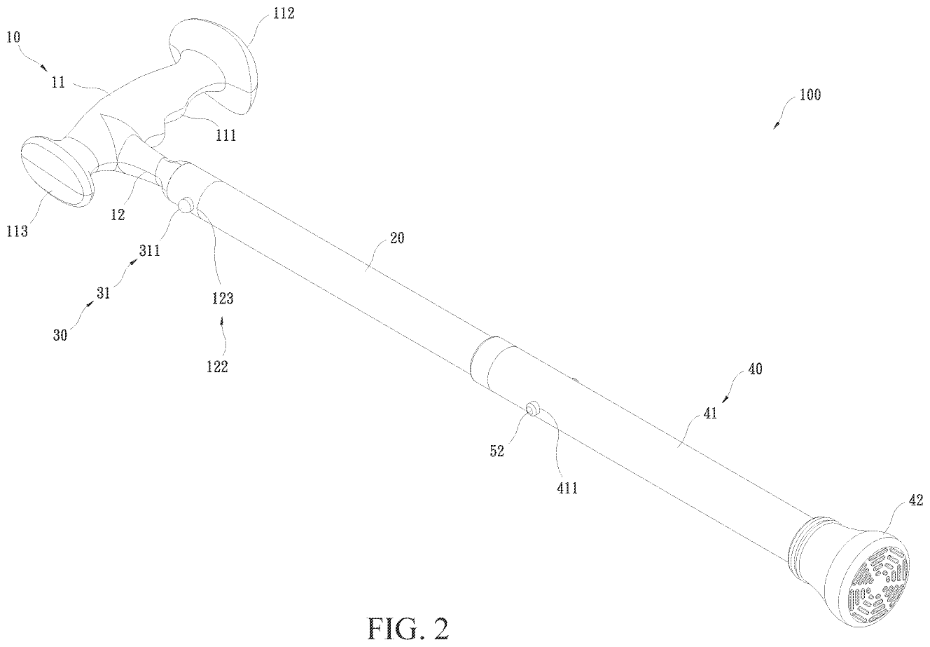

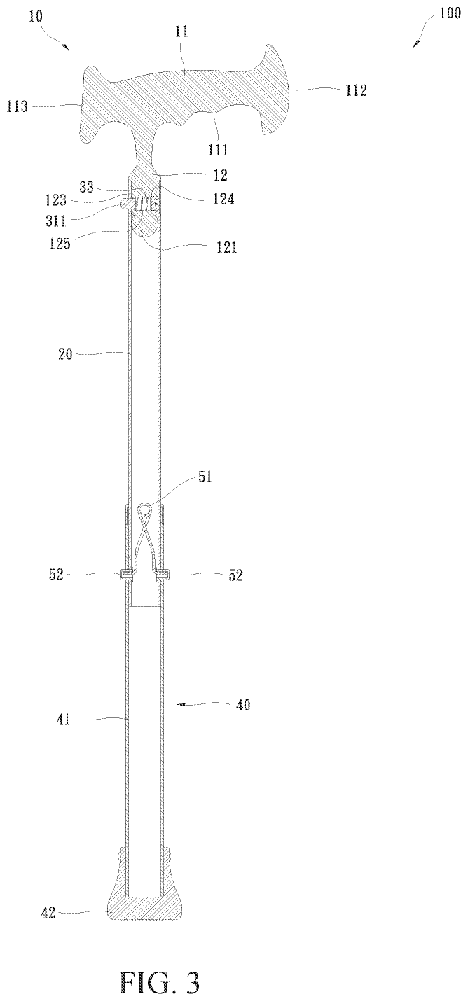

Referring to FIGS. 1-5, the present invention provides, in a first preferred embodiment, a cane 100 that also serves as a massager, mainly comprises a cane head 10, a cane body 20, a cane head mounting unit 30, a support base 40, and a support base mounting unit 50.

Referring to FIGS. 1-5, the cane head 10 is generally of a T-shape, which defines a grip portion 11 and an inserting and joining portion 12. The grip portion 11 has an outer circumferential surface that includes a gripping curve 111 for being gripped and held by a user's hand. The grip portion 11 has an end face that includes a spherical convex-surface massaging portion 112, and the spherical convex-surface massaging portion 112 is in a shape of a spherical convex surface. The grip portion 11 has an opposite end face that includes a planar-surface massaging portion 113, and the planar-surface massaging portion 113 is of a shape of a planar surface. The spherical convex-surface massaging portion 112 has a surface area that is greater than a surface area of the planar-surface massaging portion 113. The inserting and joining portion 12 has one end that is integrally connected, as a one-piece structure, to one side of the grip portion 11, and a free end of the inserting and joining portion 12 includes a massage sphere 121. The massage sphere 121 is in a shape of a sphere. The inserting and joining portion 12 has an outer circumferential surface that is formed with a through hole 122 penetrating therethrough in a radial direction, and the through hole 122 defines a penetration opening 123 at one side of the inserting and joining portion 12, a threaded opening 124 at an opposite side of the inserting and joining portion 12, and a communication hole 125 connecting between and communicating with the penetration opening 123 and the threaded opening 124. The penetration opening 123 has an opening diameter that is smaller than a hole diameter of the communication hole 125.

Referring to FIGS. 1-3 and 5, the cane body 20 comprises a straight tube that is penetrated in an axial direction. The cane body 20 has a top end into which the inserting and joining portion 12 of the cane head 10 is inserted. A penetration and retention aperture 21 is formed in an outside surface of the cane body 20 at a location adjacent to the top end to communicate the exterior with the interior. Retaining apertures 22 are formed in the outside surface of the cane body 20 at two opposite locations that are adjacent to a bottom end thereof.

Referring to FIGS. 1-4, the cane head mounting unit 30 is arranged on the inserting and joining portion 12 of the cane head 10 to mount the cane head 10, in a detachable manner, to the cane body 20. The cane head mounting unit 30 comprises a penetration and retention member 31, a threaded bolt 32, and a spring 33. The penetration and retention member 31 comprises a head portion 311 and a body portion 312 that is integrally connected, as a one-piece structure, to the head portion 311. The head portion 311 has an outside diameter that is smaller than an outside diameter of the body portion 312. The penetration and retention member 31 is disposed in the communication hole 125 of the cane head 10. The threaded bolt 32 is connected, through threading engagement, to the threaded opening 124. The spring 33 is supported between the body portion 312 of the penetration and retention member 31 and the threaded bolt 32 to provide a spring force to bias and thus push the head portion 311 of the penetration and retention member 31 to project out of the penetration opening 123. When the inserting and joining portion 12 of the cane head 10 is inserted into the top end of the cane body 20, the head portion 311 of the penetration and retention member 31 is caused to simultaneously extend through the penetration and retention aperture 21 of the cane body 20 to achieve an effect of combining the cane head 10 and the cane body 20 together.

Referring to FIGS. 1-3, the support base 40 is mounted, in a detachable manner, to the bottom end of the cane body 20 for being supported on the ground. In the instant embodiment, the support base 40 is a shock-reducing support base. The support base 40 comprises a tubular body 41 and a foot 42. The tubular body 41 is hollow in an axial direction. Mounting holes 411 are formed in an outside surface of the tubular body 41 at two opposite locations adjacent to a top end thereof to communicate with an interior thereof. The foot 42 is made of rubber and is fit to a bottom face of the tubular body 41. The top end of the support base 40 is structured to receive the bottom end of the cane body 20 to penetrate therein.

Referring to FIGS. 1-3 and 5, the support base mounting unit 50 is arranged on the bottom end of the cane body 20 to mount the cane body 20, in a detachable manner, to the support base 40. The support base mounting unit 50 comprises an elastic portion 51 and two key portions 52 connected to the elastic portion 51. The elastic portion 51 has a structure having a spring force to enable deformation upon being pressed and restoration back to an original shape when the pressing force vanishes, such as a resilient plate or a spring. The key portions 52 are respectively connected to two ends of the elastic portion 51. The support base mounting unit 50 is disposed in the interior of the bottom end of the cane body 20, and the two key portions 52 are respectively set at positions corresponding to the retaining apertures 22. The key portions 52, when not acted upon by an external force, are biased by an acting force of the elastic portion 51 to be pushed to project out of the retaining apertures 22. When the bottom end of the cane body 20 penetrates into the top end of the support base 40, the key portions 52 are caused to simultaneously extend through the mounting holes 411 of the support base 40 to allow the support base 40 and the cane body 20 to be combined together in a detachable manner by the support base mounting unit 50.

Thus, the above provides an introduction to the cane 100 that serves as a massager according to the first preferred embodiment of the present invention, as well as components and assembly thereof, and in the following, features of use will be described.

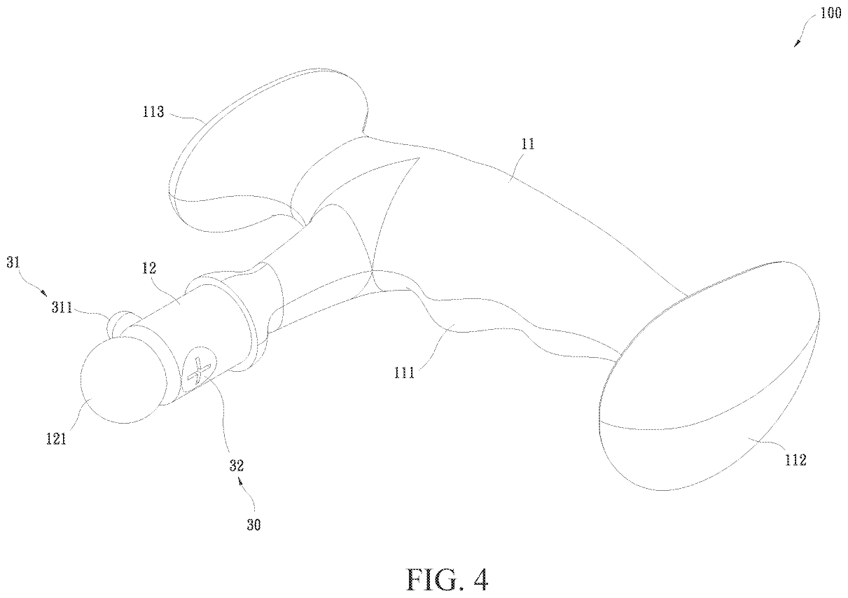

Firstly, in the instant embodiment, the support base 40 comprises a shock-reducing support base, which can be used in a general road or indoors. In case that a user desires to massage while staying at home or moving outdoors, the cane head 10 is detached from the cane body 20, such as pressing down the head portion 311 of the penetration and retention member 31 of the cane head mounting unit 30 to have the head portion 311 separate from the penetration and retention aperture 21 of the cane body 20. As such, the cane head 10 is separated from the cane body 20, as shown in FIG. 4, and in this way, the user may use the spherical convex-surface massaging portion 112, the planar-surface massaging portion 113, or the massage sphere 121 to massage various portions of the body, such as using the spherical convex-surface massaging portion 112 to massage muscles, using the planar-surface massaging portion 113 to lightly hit and knock the body, or using the massage sphere 121 to massage acupuncture points of the body, to thereby fulfill an effect that a massager is still available even staying outdoors.

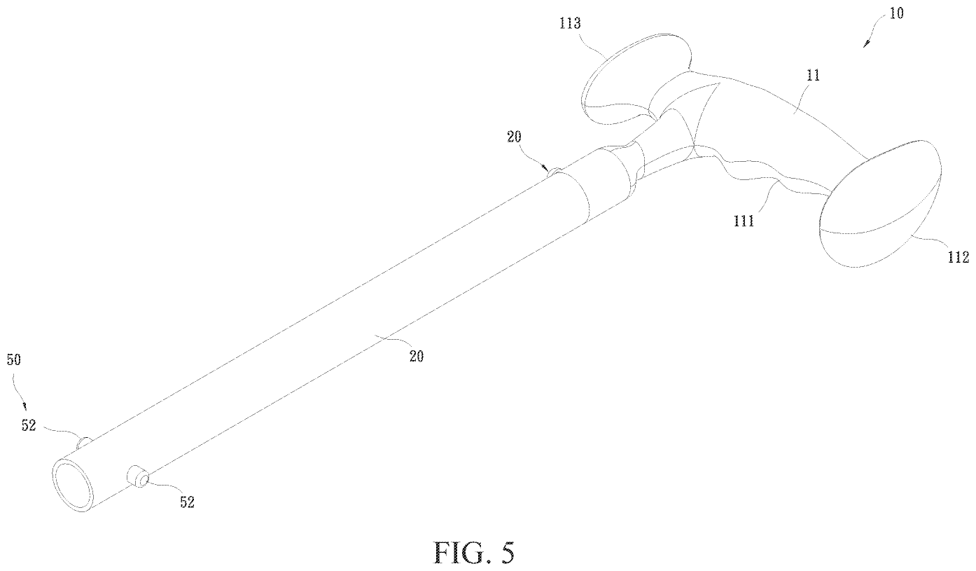

Further, if the user wishes to flap portions, such as shanks and back, that are distant from the hand, with the cane head 10 and the cane body 20 being still combined with each other, the user may press down the key portions 52 of the support base mounting unit 50 to separate the key portions 52 from the mounting holes 411 of the support base 40 to thereby detach the cane head 10 and the cane body 20, which are still combined together, from the support base 40 (as shown in FIG. 5). In this way, the user may hold the cane body 20 that is relatively long in size and uses the spherical convex-surface massaging portion 112 or the planar-surface massaging portion 113 to flap or slap lightly portions of the body to thereby make the range of application of the present invention wider and having better adaptability.

Further, although in the above embodiment, the support base is a shock-reducing support base, yet in actual applications, the support base may be a mountain-climbing support bas having a sharp tip for being useful in a mountain trail, a sandy road, or a muddy road or may alternatively be a snow-area support base having a basket for being useful for walking in a snowy area to thereby make the adaptability of the present invention better.

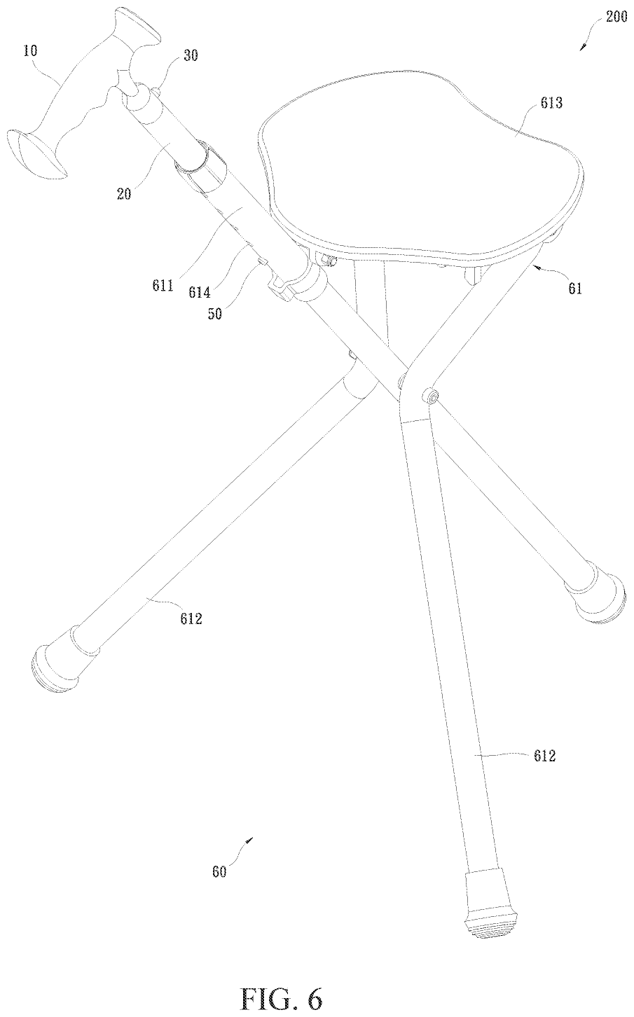

Referring to FIG. 6, a cane 200 that serves as a massager according to a second preferred embodiment of the present invention is shown, which is generally similar to the first embodiment by comprising a cane head 10, a cane body 20, a cane head mounting unit 30, a support base 60, and a support base mounting unit 50, and a primary difference of the instant embodiment from the above embodiment is as follows:

In the instant embodiment, the support base 60 is made in the form of a foldable seat 61. The foldable seat 61 comprises a connection tube 611, a plurality of seat legs 612 pivotally connected to the connection tube 611, and a seat cushion 613 pivotally connected to the connection tube 611 and the seat legs 612. The connection tube 611 comprises mounting holes 614 to receive the support base mounting unit 50 to engage therewith.

As such, the present invention allows a user to support on the ground for walking, and, after being detached, can be used for massaging, and can also allow, after expanding the support base 60, the user to sit thereon for an effect of resting.

I claim:

1. A cane serving as a massager, comprising:
a cane head, which comprises a grip portion and an inserting and joining portion, the grip portion being adapted to be gripped and held by a hand of a user, the inserting and joining portion having one end connected to one side of the grip portion, a free end of the inserting and joining portion comprising a massage sphere;
a cane body, wherein the inserting and joining portion of the cane head is mounted, in a detachable manner, in an interior of a top end of the cane body; and
a support base, which is mounted, in a detachable manner, to a bottom end of the cane body for supporting on ground.

2. The cane serving as a massager according to claim 1, wherein the cane head is of a T-shape, the grip portion having an outer circumferential surface that comprises a gripping curve, the grip portion having one end face that comprises a spherical convex-surface massaging portion, the grip portion having an opposite end face that comprises a planar-surface massaging portion, the spherical convex-surface massaging portion having a surface area greater than a surface area of the planar-surface massaging portion.

3. The cane serving as a massager according to claim 1, further comprising a cane head mounting unit, the cane head mounting unit being arranged on the inserting and joining portion of the cane head for detachably combing with the cane body.

4. The cane serving as a massager according to claim 3, wherein the inserting and joining portion has an outer circumferential surface that is formed with a through hole, penetrating therethrough in a radial direction the through hole defining a penetration opening at one side of the inserting and joining portion, a threaded opening at an opposite side of the inserting and joining portion, and a communication hole connecting between and communicating with the penetration opening and the threaded opening, the penetration opening having an opening diameter smaller than a hole diameter of the communication hole; the cane body is formed with a penetration and retention aperture in an outside surface thereof at a location adjacent to a top end thereof to communicate exterior with interior; the cane head mounting unit comprises a penetration and retention member, a threaded bolt, and a spring, the penetration and retention member comprising a head portion and a body portion that is integrally connected, as a one-piece structure, to the head portion, the head portion having an outside diameter smaller than an outside diameter of the body portion, the penetration and retention member being disposed in the communication hole of the cane head, the threaded bolt being connected, through threading engagement, to the threaded opening, the spring being supported between the body portion of the penetration and retention member and the threaded bolt to provide a spring force to bias and push the head portion of the penetration and retention member to project out of the penetration opening, wherein when the inserting and joining portion of the cane head is inserted into the top end of the cane body, the head portion of the penetration and retention member extends through the penetration and retention aperture of the cane body.

5. The cane serving as a massager according to claim 1, wherein the support base comprises one of a shock-reducing support base, a mountain-climbing support bas having a sharp tip, and a snow-area support base having a basket.

6. The cane serving as a massager according to claim 1, further comprising a support base mounting unit, the support base mounting unit being arranged on the cane body for detachably combining with the support base.

7. The cane serving as a massager according to claim 6, wherein retaining apertures are formed in an outside surface of the cane body at two opposite locations that are adjacent to a bottom end thereof; mounting holes are formed in an outside surface of the support base at two opposite locations to communicate with an interior thereof; the support base mounting unit comprises an elastic portion and two key portions connected to the elastic portions, wherein the elastic portion has a spring force to enable deformation upon being pressed and restoration back to an original shape when the pressing force vanishes, the key portions being connected to two ends of the elastic portion, the support base mounting unit being disposed in an interior of the bottom end of the cane body, the two key portions being respectively set at positions corresponding to the retaining apertures, wherein the key portions, when not acted upon by an external force, are biased by the force of the elastic portion to be pushed to project out of the retaining apertures, and when the bottom end of the cane body penetrates into the top end of the support base, the key portions extend through the mounting holes of the support base to allow the support base and the cane body to be combined together in a detachable manner by the support base mounting unit.

8. The cane serving as a massager according to claim 7, wherein the elastic portion of the support base mounting unit comprises one of a resilient plate and a spring.

9. The cane serving as a massager according to claim 1, wherein the support base comprises a tubular body and a foot, the tubular body being hollow in an axial direction, the foot being fit to a bottom face of the tubular body, a top end of the support base receiving a bottom end of the cane body to penetrate therein.

10. The cane serving as a massager according to claim 1, wherein the support base is in the form of a foldable seat, the foldable seat comprising a connection tube, a plurality of seat legs pivotally connected to [symbol] the connection tube, and a seat cushion pivotally connected to the connection tube and the seat legs, the connection tube being mounted, in a detachable manner, to a bottom end of the cane body.
